(19) United States
(12) Patent Application Publication
(10) Pub. No.: US 2011/0086248 A1
(43) Pub. Date: Apr. 14, 2011

(54) ASSEMBLED BATTERY

(76) Inventor: Kensuke Nakura, Osaka (JP)

(21) Appl. No.: 12/995,914

(22) PCT Filed: Jun. 3, 2009
(86) PCT No.: PCT/JP2009/002507

§ 371 Date: Dec. 2, 2010

(30) Foreign Application Priority Data
Jun. 4, 2008 (JP) 2008-147152

(51) Int. Cl. H01M 16/00

(52) U.S. Cl. 429/9

(57) ABSTRACT

The present invention relates to an assembled battery including a combination of two kinds of secondary batteries differing in battery property (charge voltage behavior), each secondary battery including a positive electrode, a negative electrode, a separator interposed between the positive and negative electrodes, and a non-aqueous electrolyte. That is, the present invention relates to an assembled battery including at least one first cell and at least one second cell electrically connected in series. The second cell has a greater change in charge voltage at the end of charge and a larger cell capacity. Thus, an assembled battery having excellent long-term reliability and excellent safety during overcharge can be obtained.

### TECHNICAL FIELD

The present invention relates to an assembled battery using a plurality of unit cells.

### BACKGROUND ART

Conventionally, lead-acid batteries having excellent high-rate discharge characteristics are widely used as batteries for starting vehicle engines and as backup power sources for various industrial and commercial uses. They are also being considered for use in electric vehicles (EVs) and hybrid electric vehicles (HEVs).

However, in recent years, clean and lead-free nickel-metal hydride batteries or non-aqueous electrolyte secondary batteries such as lithium-ion secondary batteries having a higher energy density than lead-acid batteries are beginning to be used as backup power sources, for the purpose of miniaturizing power sources and reducing environmental burdens.

Even nowadays, lead-acid batteries are widely used as batteries for starting vehicle engines. However, the use of lithium-ion secondary batteries are being considered as power sources for idle reduction. Also, nickel-metal hydride batteries are used in HEVs as typified by cars such as “Prius” (product name).

For lithium-ion secondary batteries used as the power source for compact mobiles, a technology that ensures high-level safety and reliability without any decrease in energy density even when used for ten years or longer, is established. Also, cost reduction of lithium-ion secondary batteries is nearing reality. Therefore, anticipation is becoming higher for high-performance lithium-ion secondary batteries as backup power sources and for in-car use.

Studies on electrode active materials are carried out extensively for lithium-ion secondary batteries. For example, NPL 1 proposes use of LiAl_{0.1}Mn_{1.9}O₄ as the positive electrode and Li_{4/3}Ti_{5/3}O₄ as the negative electrode. Also, PTL 1 proposes use of Li₁₋ₐNi_{1/2-x}Mn_{1/2-x}CoₓO₂ (a≦1, x<1/2) as the positive electrode and Li_{4/3}Ti_{5/3}O₄ as the negative electrode.

### [Citation List]

### [Patent Literature]

### [PTL 1] Japanese Laid-Open Patent Publication No. 2005-142047

### [Non Patent Literature]

### [NPL 1] Chemistry Letters, the Chemical Society of Japan, 2006, 35, 848-849.

### SUMMARY OF INVENTION

### Technical Problem

In NPL 1, an assembled battery having a voltage of 6 V, 12 V, or 24 V is constituted, by connecting in series a plurality of unit cells each using LiAl_{0.1}Mn_{1.9}O₄ as the positive electrode active material and Li_{4/3}Ti_{5/3}O₄ as the negative electrode active material. When this assembled battery is subjected to charge control as one group, the respective potentials of the positive electrode and the negative electrode drastically change at the end of charge. Therefore, even with the slightest variation in capacity among unit cells, variation in charge voltage thereamong becomes larger. In this case, the unit cell having a small capacity tends to become easily overcharged, which may cause decline in long-term reliability of the assembled battery. Therefore, for the assembled battery of NPL 1 in which a plurality of lithium-ion cells are connected in series, it is necessary to control charging in each unit cell for protection from overcharge. However, when an assembled battery of lithium-ion secondary cells is used as backup power sources and vehicle engine starters, charge control in each unit cell as described above leads to a significant cost increase.

In addition, a method by which cell voltage is monitored per unit cell and current is controlled only at both ends of an assembled battery can be considered. However, by this method, charging ends depending on the unit cell having the smallest capacity. Therefore, performance of the assembled battery would not be sufficiently delivered. As such, this technique is not particularly effective in terms of performance of the assembled battery.

Further, in the case of the battery of PTL 1 in which Li₁₋ₐNi_{1/2-x}Mn_{1/2-x}CoₓO₂ (a≦1, x<1/2) is used as the positive electrode and Li_{4/3}Ti_{5/3}O₄ is used as the negative electrode, it is usual for charging to be carried out until “a” in the above formula equals to about 0.3 to 0.5, at a normal end-of-charge voltage (4.2 to 4.4 V in the case of a negative electrode made of graphite). When such a battery becomes overcharged due to control device malfunction or the like, lithium becomes further deintercalated and thermal stability of the positive electrode may decline significantly.

Therefore, an object of the present invention is to provide an assembled battery with excellent long-term reliability and excellent stability during overcharge, so as to solve the conventional problem as described above.

### Solution to Problem

The present invention is an assembled battery constituted of at least one first cell and at least one second cell connected in series, in which the second cell has a greater change in charge voltage at the end of charge and a larger cell capacity, compared to the first cell.

A positive electrode active material of the first cell is preferably a lithium-containing composite oxide having a layered structure.

The lithium-containing composite oxide is preferably represented by a general formula (1):

Li₁₊ₐ[Me]O₂

where Me is at least one selected from the group consisting of Ni, Mn, Fe, Co, Ti, and Cu; and

The lithium-containing composite oxide is preferably represented by a general formula (2):

Li₁₊ₐ[Ni_{1/2-z}Mn_{1/2-z}Co_{2z}]O₂

where 0≦a≦0.2 and z≦1/6.

A positive electrode active material of the second cell is preferably a lithium-containing manganese composite oxide having a spinel structure.

The lithium-containing manganese composite oxide is preferably represented by a general formula (3):

Li₁₊ₓMn_{2-x-y}A_{y}O₄

where A is at least one selected from the group consisting of Al, Ni, Co, and Fe; 0≦x<1/3; and 0≦y≦0.6.

A positive electrode active material of the second cell is preferably a phosphate compound having an olivine structure.

The phosphate compound is preferably represented by a general formula (4):

Li₁₊ₐMPO₄

where M is at least one selected from the group consisting of Mn, Fe, Co, Ni, Ti, and Cu; and −0.5≦a≦0.5.

A negative electrode active material of at least one of the first cell and the second cell is preferably a lithium-containing titanium oxide.

The lithium-containing titanium oxide is preferably represented by a general formula (5):

Li₃₊₃ₓTi₆₋₃ₓO₁₂

where 0≦x≦1/3.

The lithium-containing titanium oxide is preferably made of a mixture of primary particles with a particle size of 0.1 to 8 μm and secondary particles with a particle size of 2 to 30 μm.

A negative electrode current collector of at least one of the first cell and the second cell is preferably made of aluminum or an aluminum alloy.

The first cell preferably differs from the second cell in size.

The first cell preferably differs from the second cell in color.

It is preferable that a first identification marking is attached on a surface of the first cell, a second identification marking is attached on a surface of the second cell, and the first cell can be identified from the second cell due to the first identification marking and the second identification marking.

### ADVANTAGEOUS EFFECTS OF INVENTION

According to the present invention, an assembled battery capable of having improved long-term reliability due to reduced variation in capacity and improved safety during overcharge can be provided, by optimizing the combination of the positive electrode active material and the negative electrode active material, the balance between the positive electrode capacity and the negative electrode capacity, and the constitution of the assembled battery. Thermal stability of the positive electrode during overcharge is ensured. Charge/discharge control can be simplified, since the assembled battery has a high tolerance for variation in capacity.

### BRIEF DESCRIPTION OF DRAWINGS

FIG. 1A schematic vertical sectional view of a non-aqueous electrolyte secondary battery used in assembled batteries of examples of the present invention.

FIG. 2 A diagram showing the charge curve of an assembled battery A1 of Example 1 of the present invention.

FIG. 3 A diagram showing the charge curve of an assembled battery A2 of Example 2 of the present invention.

FIG. 4 A diagram showing the charge curve of an assembled battery B1 of conventional Comparative Example 1.

FIG. 5 A diagram showing the charge curve of an assembled battery C1 of conventional Comparative Example 2.

FIG. 6 A diagram showing the charge curve of an assembled battery B2 of conventional Comparative Example 3.

FIG. 7 A diagram showing the charge curve of an assembled battery C2 of conventional Comparative Example 4.

### DESCRIPTION OF EMBODIMENTS

The present invention relates to an assembled battery constituted by combining two kinds of secondary batteries differing in battery property (charge voltage behavior), each secondary battery including a positive electrode, a negative electrode, a separator disposed therebetween, and a non-aqueous electrolyte.

That is, it is an assembled battery in which at least one first cell and at least one second cell are electrically connected in series, the second cell having a greater change in charge voltage at the end of charge and a larger cell capacity compared to the first cell.

The assembled battery of the present invention is constituted of at least one first cell and at least one second cell electrically connected in series. The assembled battery may also be constituted of a plurality of unit cells of the same kind, electrically connected in series. Also, examples of the assembled battery of the present invention include a battery module in which a plurality of unit cells are integrated into one battery container.

Herein, a change in charge voltage means the change in charge voltage during constant-current charge. Also, the charge voltage at the end of charge means the end-of-charge voltage (upper voltage limit) that is set for a conventional lithium-ion secondary battery. The end-of-charge voltage is, for example, 4.2 to 4.4 V when a negative electrode active material is a carbon material (e.g., graphite), and 2.7 to 3.0 V when a negative electrode active material is a lithium-containing titanium oxide (e.g., lithium titanium oxide). Further, when an active material with a high potential such as a lithium nickel manganese oxide having a spinel structure is used in a positive electrode, the end-of-charge voltage is 4.5 to 4.8 V (in the case where a negative electrode active material is a carbon material).

The assembled battery constituted by combining the first cell and the second cell exhibits a charge voltage behavior characterized by change in the charge voltage being smaller at the end of charge (about 100% SOC), compared to an assembled battery constituted solely of the second cells, and by the charge voltage increasing more in the overcharge region where the SOC exceeds 100%, compared to when an assembled battery is constituted solely of the first cells.

Herein, SOC indicates the state of charge and is the value expressed in percentage, of quantity of electricity charged relative to battery capacity (theoretical capacity). When SOC is 100%, it means that the battery is fully charged.

Since the first cell exhibits smaller change in charge voltage at the end of charge compared to the second cell, variation in capacity among unit cells can be reduced, compared to an assembled battery constituted solely of the first cells. Even if variation in capacity is present among unit cells, variation in end-of-charge voltage thereamong does not increase.

When the assembled battery is overcharged to a voltage exceeding the end-of-charge voltage, the second cell exhibits a greater change in charge voltage and has a smaller overcharge region (SOC) compared to the first cell. Therefore, the overcharge current flowing in the assembled battery can be further reduced, compared to when an assembled battery is constituted solely of the first cells.

The combined use of the first cell and the second cell decreases variation in capacity among unit cells and improves long-time reliability while also improving safety during overcharge.

In the first cell, it is preferable that the change in charge voltage relative to amount of charge is small at the end of charge (80 to 110% SOC), in such a manner that, for example, a charge curve of which the horizontal axis is designated as an amount of charge Q (SOC (%)) and the vertical axis is designated as a charge voltage V (V) shows a slope (ΔV/ΔQ) of the charge curve at 100% SOC as being 0.01 or smaller.

In the second cell, it is preferable that the change in charge voltage relative to amount of charge increases drastically at the end of charge (90 to 110% SOC) thereby making the overcharge region small, in such a manner that, for example, a charge curve of which the horizontal axis is designated as an amount of charge Q (SOC (%)) and the vertical axis is designated as a charge voltage V (V) shows a slope (ΔV/ΔQ) of the charge curve at 100% SOC as being 0.01 or larger.

Note that the respective charge curves of the above first cell and second cell each show change in closed circuit voltage of the cell at times of constant current charge carried out at a predetermined current value. The slope (ΔV/ΔQ) of the charge curve at the end of charge is larger for the second cell than the first cell.

With respect to the first cell, it is preferable that the slope (ΔV/ΔQ) of the charge curve at 100% SOC is 0.001 to 0.01 when the cell is charged at a constant current of 0.2 to 4 CA.

With respect to the second cell, the slope (ΔV/ΔQ) of the charge curve at 100% SOC is 0.01 to 0.2 when the cell is charged at a constant current of 0.2 to 4 CA.

Note that C is the hour rate, and (1/X)CA=rated capacity (Ah)/X (h), where X represents the time consumed for charging or discharging electricity equivalent to the rated capacity. For example, 0.5 CA means that the current value is equal to rated capacity (Ah)/2 (h).

In addition, the cell capacity of the second cell is preferably larger than that of the first cell by 5% or more. This is to prevent the cell capacity of the second cell from becoming smaller than that of the first cell, even when variation in capacity occurs among the second cells, such variation being inevitable in manufacturing. More preferably, the cell capacity of the second cell is larger than that of the first cell by 5 to 10%.

The assembled battery constituted by combining the above first cell and second cell exhibits a charge voltage behavior characterized by change in charge voltage being small at the end of charge (about 100% SOC) and charge voltage increasing drastically in the overcharge region where SOC exceeds 100%.

At the end of charging the assembled battery, the charge voltage behavior prevails for the first cell, in which change in charge voltage relative to electrochemical capacity (amount of charge) is small at the end of charge. Therefore, the first cell enables remarkable suppression of variation in capacity among unit cells. Even when variation in capacity is present among unit cells, variation in end-of-charge voltage thereamong does not increase.

When the assembled battery is overcharged to a voltage exceeding the end-of-charge voltage, charge voltage increases drastically and charge characteristics of the second cell, whose overcharge region is small, appears. Thus, the overcharge current flowing in the assembled battery becomes significantly attenuated. As such, the second cell enables remarkable improvement in safety during overcharge. Also, since the overcharge region for the second cell is extremely small, thermal stability of the positive electrode active material used in the second cell does not change much between when the cell is in a normally-charged state and when the cell is in an overcharged state, thereby ensuring thermal stability of the positive electrode.

As above, the combined use of the first cell and the second cell enables an assembled battery having excellent long-term reliability and excellent stability during overcharge to be obtained.

It is preferable that in the assembled battery, the proportion of the first cell is made as large as possible and the proportion of the second cell is made as small as possible, since this would enable the above charge voltage behavior to be easily obtained and the above effect to be more remarkably obtained.

When the assembled battery is made solely of a plurality of the second cells and variation in capacity increases among the unit cells, variation in voltage at the end of charge increases, thereby causing the cell having a small capacity to become overcharged. Due to the above, long-term reliability tends to decline easily.

Also, when the assembled battery is made solely of a plurality of the first cells, control errors due to device malfunction or the like causes the amount of overcharge to increase, and thermal stability of the positive electrode may decline significantly.

An embodiment (each component and production method thereof) of the assembled battery of the present invention will be explained below.

### (1) Positive Electrode

The positive electrode is constituted of, for example, a positive electrode current collector and a positive electrode material mixture layer formed thereon.

The positive electrode material mixture layer contains, for example, a positive electrode active material, a conductive material, and a binder.

A first positive electrode active material described below is preferably used in the first cell.

The first positive electrode active material is preferably a positive electrode material by which a small change is caused in the positive electrode potential at the end of charge. For example, a lithium-containing composite oxide having a layered structure is preferable.

The lithium-containing composite oxide having a layered structure is preferably a lithium-containing composite oxide (hereinafter referred to as compound (1)) represented by a general formula (1):

Li₁₊ₐ[Me]O₂

where Me is at least one selected from the group consisting of Ni, Mn, Fe, Co, Ti, and Cu; and 0≦a≦0.2.

The compound (1) is synthesized, for example, by mixing in such a manner that a predetermined composition is attained, an oxide, hydroxide, or carbonate containing elements which compose the positive electrode active material and then baking the resultant mixture. When the compound (1) is synthesized by using a raw material made of the respective powders of two or more transition metals dispersed at the nano level, it is preferable that the finest possible raw material powder is mixed sufficiently with use of a device for pulverizing and mixing, such as a ball mill.

From the aspect of thermal resistance of the cell, the compound (1) is preferably a lithium composite oxide (hereinafter referred to as compound (2)) represented by a general formula (2):

Li₁₊ₐ[Ni_{1/2-z}Mn_{1/2-z}Co_{2z}]O₂

where 0≦a≦0.2 and z≦1/6.

The compound (2) may be produced in the same manner as described above. However, it is difficult for the respective powders of nickel and manganese to be dispersed. Therefore, it is preferable to synthesize the compound (2) by producing a composite hydroxide (oxide) containing nickel and manganese in advance by a method such as coprecipitation, and then using it as a raw material. For example, it is preferable to sufficiently mix [Ni_{1/2-z}Mn_{1/2-z}Co_{2z}] (OH)₂ together with lithium hydroxide, forming the resultant mixture into a pellet, and then baking the pellet. The baking temperature in this case is, for example, about 900 to 1100° C.

A second positive electrode active material described below is preferably used in the second cell.

The second positive electrode active material is preferably a positive electrode material by which a significant change is caused in the positive electrode potential at the end of charge. Specifically, a lithium-containing manganese composite oxide having a spinel structure or a phosphate compound having an olivine structure is preferable.

The lithium-containing manganese composite oxide having a spinel structure is preferably a lithium-containing composite oxide (hereinafter referred to as compound (3a)) represented by a general formula (3a):

Li[LiₓMn₂₋ₓ]O₄

where 0<x<0.33.

The compound (3a) can be produced, for example, in the following manner. Manganite (MnOOH) and lithium hydroxide (LiOH) are sufficiently mixed in such a manner that a desired composition is attained, and the resultant mixture is then subjected to baking (first baking) at about 500 to 600° C. in air for about 10 to 12 hours. At this time, the baked material (powder) thus obtained may be pressed to form a pellet, if necessary. Alternatively, the above baked material (powder) may be granulated. This baked material from the first baking is pulverized, and the pulverized material thus obtained is subjected to baking (second baking) at about 700 to 800° C. in air for about 10 to 12 hours. In this manner, the desired positive electrode active material can be synthesized.

The lithium-containing manganese oxide having a spinel structure is also preferably a lithium-containing composite oxide (hereinafter referred to as compound (3)) represented by a general formula (3):

Li₁₊ₓMn_{2-x-y}A_{y}O₄

where A is at least one selected from the group consisting of Al, Ni, Co, and Fe; 0≦x≦1/3; and 0≦y≦0.6.

The compound (3) can be produced, for example, in the following manner. At least one selected from the group consisting of aluminum hydroxide (Al(OH)₃), Ni(OH)₂, Co(OH)₂, and FeOOH is mixed in manganite and lithium hydroxide in such a manner that a desired composition is attained. Thereafter, the resultant mixture is baked in the same manner as the compound (3a). When Ni(OH)₂ is used and there is an increase in its added amount, it would be difficult for nickel and manganese to be mixed and dispersed sufficiently at the nano level. Therefore, it would be preferable to set a high temperature for the first baking temperature to enable these to be dispersed sufficiently. For example, the first baking temperature is preferably set to about 900 to 1100° C. In this case, it is preferable to set the second baking temperature to a low temperature of about 600 to 800° C., and to designate this setting as the temperature condition for replenishing oxygen which tends to be lacking during baking at high temperatures.

Further, for nickel and manganese to be sufficiently dispersed at the atomic level, a composite hydroxide containing nickel and manganese is preferably produced in advance to be used as a raw material. For example, when producing Li[Ni_{1/2}Mn_{3/2}]O₄, a composite hydroxide (oxide) is produced by a method such as coprecipitation, in such a manner that the ratio of nickel to manganese is 1 to 3. The composite oxide thus obtained is sufficiently mixed with lithium hydroxide, and the resultant mixture is then rapidly heated to, for example, about 1000° C. The temperature is held at about 1000° C. for about 12 hours, and then lowered to about 700° C. The temperature is held at about 700° C. for about 48 hours, and then naturally cooled down to room temperature.

The phosphate compound having an olivine structure is preferably a compound (hereinafter referred to as compound (4)) represented by a general formula (4):

Li₁₊ₐMPO₄

where M is at least one selected from the group consisting of Mn, Fe, Co, Ni, Ti, and Cu, and −0.5≦x≦0.5.

M is more preferably Mn or Fe, from the aspect of the operating voltage falling within the range of about 3 to 4 V which is usually used for lithium ion batteries.

The above compound (4) can be produced, for example, in the following manner. An oxide, hydroxide, carbonate, oxalate, or acetate containing the elements M and Li composing the desired positive electrode active material is mixed with ammonium phosphate in such a manner that a predetermined composition is attained. This mixture is baked under a reducing atmosphere. In this manner, a phosphate compound can be synthesized. When a phosphate compound is synthesized by using a raw material made of two or more transition metal powders dispersed at the nano level, it is preferable that the finest possible raw material powder is mixed sufficiently with use of a device for pulverizing and mixing such as a ball mill. Also, in order to increase conductivity, a carbon source such as organic matter may be mixed in the raw material and then baked.

The conductive material for the positive electrode is not particularly limited as long as it is an electron-conductive material by which chemical change is not easily caused during charge and discharge of a non-aqueous electrolyte secondary battery. Examples include: carbon blacks such as acetylene black, ketjen black, channel black, furnace black, lamp black, and thermal black; conductive fibers such as carbon fiber and metallic fiber; fluorinated carbon; metallic powders such as those of copper, nickel, aluminum, and silver; conductive metal oxides such as zinc oxide, potassium titanate, and titanium oxide; and organic materials having conductivity such as polyphenylene derivatives. These can be used alone or in a combination of two or more. Typically, the conductive material content in the positive electrode material mixture layer is preferably 0 to 10 mass % and more preferably 0 to 5 mass %, although not particularly limited thereto.

The binder for the positive electrode is preferably a polymer with an onset decomposition temperature of 200° C. or higher, by which chemical change is not easily caused during charge and discharge of a non-aqueous electrolyte secondary battery. Examples include: polyvinylidene fluoride (PVdF), polyethylene (PE), polypropylene (PP), polytetrafluoroethylene (PTFE), tetrafluoroethylene-hexafluoropropylene copolymers (FEP), tetrafluoroethylene-perfluoro(alkyl vinyl ether) copolymers (PFA), vinylidene fluoride-hexafluoropropylene copolymers, vinylidene fluoride-chlorotrifluoroethylene copolymers, ethylene-tetrafluoroethylene copolymers (ETFE resin), polychlorotrifluoroethylene (PCTFE), vinylidene fluoride-pentafluoropropylene copolymers, propylene-tetrafluoroethylene copolymers, ethylene-chlorotrifluoroethylene copolymers (ECTFE), vinylidene fluoride-hexafluoropropylene-tetrafluoroethylene copolymers, and vinylidene fluoride-perfluoro(methyl vinyl ether)-tetrafluoroethylene copolymers; or rubber materials having binding property such as a styrene butadiene-based rubber (SBR). These may be used alone or in a combination of two or more. Among the above, PVdF, SBR, and PTFE are preferable.

The positive electrode current collector is not particularly limited as long as it is an electron-conductive material by which chemical change is not easily caused during charge and discharge of a non-aqueous electrolyte secondary battery. Examples include stainless steel, nickel, aluminum, copper, titanium, alloys, and carbon, and furthermore, a composite material made of aluminum or stainless steel that is surface-treated with carbon, nickel, titanium, or silver may also be used. Such materials with oxidized or roughened surface may also be used.

Also, the form of the positive electrode current collector is not particularly limited as long as it is such conventionally used for a positive electrode of a non-aqueous electrolyte secondary battery. Examples include a foil, a film, a sheet, a net, a punched matter, a lath, a porous matter, a foam, a fiber, and a non-woven fabric. The thickness of the positive electrode current collector is preferably 1 to 500 μm.

The positive electrode can be produced in the following manner. A positive electrode active material, a conductive material such as acetylene black, and a binder such as PVdF are mixed sufficiently, and then a solvent such as N-methyl-2-pyrrolidone is added to the resultant mixture, to obtain a positive electrode slurry. The positive electrode slurry is applied to a positive electrode current collector made of aluminum foil and then dried, for example, under predetermined conditions, to obtain a positive electrode constituted of the positive electrode current collector with a positive electrode material mixture layer formed thereon. The thickness and filling density of the positive electrode may be changed as appropriate in accordance with battery design (balance between the positive electrode capacity and the negative electrode capacity). For example, at the time of testing such as for electrochemical measurement, the positive electrode thickness may be set to, for example, about 0.2 to 0.3 mm, and the density of the positive electrode material mixture layer may be set to, for example, about 1.0 to 3.0 g/cm³.

### (2) Negative Electrode

The negative electrode is constituted of, for example, a negative electrode current collector and a negative electrode material mixture layer formed thereon. The negative electrode material mixture layer contains, for example, a negative electrode active material, a negative electrode conductive material, and a negative electrode binder.

The respective negative electrode active materials used in the first cell and the second cell may be a conventionally-used material. Examples include a metal, metallic fiber, carbon material, oxide, nitride, tin compound, and silicon compound or a composite containing an alloy and lithium, all capable of absorbing and desorbing lithium. Among the above, preferable are a carbon material such as natural graphite and artificial graphite, and a lithium-containing titanium oxide.

The lithium-containing titanium oxide is preferably an oxide (hereinafter referred to as compound (5)) represented by a general formula (5):

Li₃₊₃ₓTi₆₋₃ₓO₁₂

where 0≦x≦1/3. Note that Ti in Li₄Ti₅O₁₂ (when x=1/3 in Li₃₊₃xTi₆₋₃ₓO₁₂) has a valence of 4.

The compound (5) can be produced, for example, in the following manner. A lithium compound such as lithium carbonate (Li₂CO₃) and lithium hydroxide (LiOH) is mixed with titanium oxide (TiO₂) in such a manner that a desired composition is attained. The resultant mixture is then baked at a predetermined temperature (e.g., about 800 to 1000° C.) under an oxidative atmosphere such as in air and in an oxygen stream.

From the aspect of filling ability, the above lithium-containing titanium oxide is made of a mixture (powder mixture) of primary particles (crystalline particles) having a particle size of 0.1 to 8 μm and secondary particles having a particle size of 2 to 30 μm. Note that a secondary particle is an agglomeration of a plurality of primary particles and has a particle size larger than that of the primary particle. The proportion of the secondary particles in the mixture of the secondary and primary particles is preferably 1 to 80 wt %.

When Li is allowed to be absorbed by the negative electrode active material as a countermeasure against overdischarge (reverse charge), the valence of Ti may be set to less than 4. For example, Li₃₊₃xTi₆₋₃ₓO₁₂ (x<1/3) or Li_{1.035}Ti_{1.965}O₄ may be used. Li₄Ti₅O₁₂ having a spinel structure is included in commercially-available batteries, enabling consumers to purchase such batteries of high quality.

When a lithium-containing titanium oxide is used as the negative electrode active material, aluminum foil or aluminum-alloy foil is preferably used as the negative electrode current collector.

The conductive material for the negative electrode used to increase conductivity of the negative electrode is not particularly limited, as long as it is an electron-conductive material by which chemical change is not easily caused during charge and discharge of a non-aqueous electrolyte secondary battery. The material may be the same as the conductive material for the positive electrode.

Typically, the conductive material content in the negative electrode material mixture layer is preferably 0 to 10 mass % and more preferably 0 to 5 mass %, although not particularly limited thereto.

The binder for the negative electrode is preferably a polymer with an onset decomposition temperature of 200° C. or higher, by which chemical change is not easily caused during charge and discharge of a non-aqueous electrolyte secondary battery. The material may be the same as the binder for the positive electrode.

The negative electrode current collector is not particularly limited, as long as it is an electron-conductive material by which chemical change is not easily caused during charge and discharge of a non-aqueous electrolyte secondary battery. Examples include aluminum, an aluminum alloy such as an Al—Cd alloy, stainless steel, nickel, copper, titanium, and carbon, and furthermore, a material made of copper or stainless steel that is surface-treated with carbon, nickel, titanium, or silver may also be used. Any of the above materials whose surface is oxidized or roughened may also be used. From the aspect of reducing the respective weights of the unit cells and the assembled battery, aluminum or an aluminum alloy is particularly preferably used as the negative electrode current collector. The negative electrode current collector made of aluminum or an aluminum alloy is used, for example, when the negative electrode active material is an oxide or nitride capable of absorbing and desorbing lithium. Also, the form of the negative electrode current collector is not particularly limited as long as it is such conventionally used for a negative electrode of a non-aqueous electrolyte secondary battery. Examples include a foil, a film, a sheet, a net, a punched matter, a lath, a porous matter, a foam, a fiber, and a non-woven fabric. The thickness of the negative electrode current collector is preferably 1 to 500

The negative electrode is produced, for example, in the following manner. A conductive material such as acetylene black, a binder such as PVdF, and a solvent such as NMP are added to a negative electrode active material, to obtain a negative electrode slurry. The negative electrode slurry is applied to a negative electrode current collector made of aluminum foil and then dried, to obtain a negative electrode constituted of the negative electrode current collector with a negative electrode material mixture layer formed thereon. At this time, the thickness and filling density of the negative electrode may be changed as appropriate in accordance with battery design (balance between the positive electrode capacity and the negative electrode capacity). At the time of testing such as for electrochemical measurement, for example, the negative electrode thickness may be set to about 0.2 to 0.3 mm and the density of the negative electrode material mixture layer may be set to about 1.0 to 2.0 g/cm³.

### (3) Other Components

For components other than the above in the unit cell (non-aqueous electrolyte secondary battery) of the present invention, those that are conventionally known may be used.

A microporous polyolefin film or a non-woven fabric, for example, may be used as the separator. A non-woven fabric is high in electrolyte retention capacity and is effective in improving rate characteristics, particularly pulse characteristics. Also, in the case of a non-woven fabric, a high-level and complex production process as that for a porous film would not be necessary, thereby widening the range for selecting the separator material while also lowering costs.

The separator material, considering its application to the non-aqueous electrolyte secondary battery of the present invention, is preferably polyethylene, polypropylene, polybutylene terephthalate, or a mixture of the above. Polyethylene and polypropylene are stable for a non-aqueous electrolyte. When strength under a high-temperature environment is required, polybutylene terephthalate is preferable.

The fiber diameter of the fiber material forming the separator is preferably about 1 to 3 μm. The fiber material, a part of which there is fusion among fibers due to processing by heated calendar rolls, is effective in reducing thickness as well as further strengthening the separator.

For the non-aqueous electrolyte, those that are conventionally used in a non-aqueous electrolyte secondary battery may be used. A non-aqueous electrolyte is made of, for example, an organic solvent and a lithium salt dissolved therein.

Examples of the organic solvent include, for example: cyclic carbonates such as ethylene carbonate (EC), propylene carbonate (PC), butylene carbonate (BC), and vinylene carbonate; cyclic carboxylic acid esters such as γ-butyrolactone (GBL); non-cyclic carbonates such as dimethyl carbonate (DMC), diethyl carbonate (DEC), ethyl methyl carbonate (EMC), and dipropyl carbonate (DPC); aliphatic carboxylic acid esters such as methyl formate (MF), methyl acetate (MA), methyl propionate (MP), and ethyl propionate (EP); a mixed solvent containing a cyclic carbonate and a non-cyclic carbonate; a mixed solvent containing a cyclic carboxylic acid ester; and a mixed solvent containing a cyclic carboxylic acid ester and a cyclic carbonate. Note that the content of the aliphatic carboxylic acid ester in the organic solvent is preferably 30% or less and more preferably 20% or less.

Other than the above, trimethyl phosphate (TMP) or triethyl phosphate (TEP), sulfolane (SL), methyldiglyme, acetonitrile (AN), propionitrile (PN), butyronitrile (BN), 1,1,2,2-tetrafluoroethyl-2,2,3,3-tetrafluoropropyl ether (TFETFPE), 2,2,3,3-tetrafluoropropyl difluoromethyl ether (TFPDFME), methyl difluoroacetate (MDFA), ethyl difluoroacetate (EDFA), or a fluorinated ethylene carbonate may also be used. These can be used alone or in a combination of two or more.

Examples of the lithium salt include: a combination of inorganic anions and lithium cations; and a combination of organic anions and lithium cations. For example, LiClO₄, LiBF₄, LiPF₆, LiAlCl₄, LiSbF₆, LiSCN, LiCF₃SO₃, LiCF₃CO₂, LiCF₃SO₂, LiAsF₆, LiB₁₀Cl₁₀, lithium lower aliphatic carboxylate, chloroborane lithium, lithium tetraphenyl borate, and imides such as LiN(CF₃SO₂) (C₂F₅SO₂), LiN(CF₃SO₂)₂, LiN(C₂F₅SO₂)₂, and LiN(CF₃SO₂) (C₄F₉SO₂) can be given. These can be used alone or in a combination of two or more. Among the above, LiPF₆ is preferable. The concentration of the lithium salt in the non-aqueous electrolyte is preferably 0.2 to 2 mol/L.

A solid electrolyte may also be used as the non-aqueous electrolyte. The solid electrolyte can be classified into an inorganic solid electrolyte and an organic solid electrolyte. Examples of the inorganic solid electrolyte include a nitride, sulfide, halide, and oxoacid salt of lithium. Particularly preferable are 80Li₂S-20P₂O₅, Li₃PO₄-63Li₂S-36SiS₂, 44LiI-38Li₂S-18P₂S₅, Li_{2.9}PO_{3.3}N_{0.46}, Li_{3.25}Ge_{0.25}P_{0.75}S₄, La_{0.56}Li_{0.33}TiO₃, and Li_{1.3}Al_{0.3}Ti_{1.7}(PO₄)₃. Also, when the materials are sintered, a sintered mixture material such as LiF and LiBO₂ may be used to form a solid electrolyte layer at the bonded interface of the materials.

Examples of the organic solid electrolyte include polymer materials such as: polyethylene oxide, polypropylene oxide, polyphosphazene, polyaziridine, polyethylene sulfide, polyvinyl alcohol, polyvinylidene fluoride, and polyhexafluoropropylene; and derivatives, mixtures, and composites thereof. These can be used alone or in a combination of two or more. Among the above, particularly preferable are a copolymer of vinylidene fluoride and hexafluoropropylene and a mixture of polyvinylidene fluoride and polyethylene oxide. A gelled electrolyte in which an organic solid electrolyte is impregnated with a non-aqueous liquid electrolyte may also be used.

### (4) Unit Cell

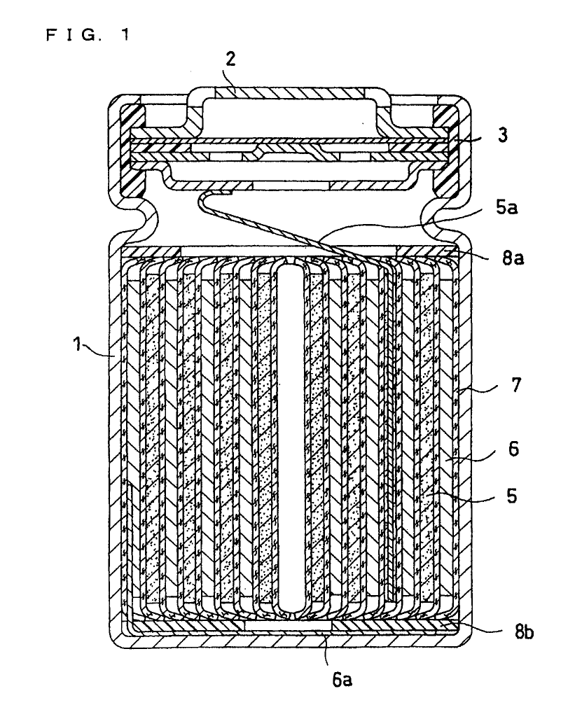

In the following, an explanation will be given with reference to FIG. 1, on the constitution of a non-aqueous electrolyte secondary battery serving as an example of the unit cell used in the assembled battery according to the present invention. FIG. 1 is a schematic vertical sectional view of the non-aqueous electrolyte secondary battery.

As illustrated in FIG. 1, housed inside a battery case 1 is an electrode group including a positive electrode 5 and a negative electrode 6 wound with a separator 7 interposed therebetween, the separator 7 being made of, for example, polyethylene. Insulating rings 8a and 8b are disposed at the top and bottom of the electrode group, respectively. A positive electrode lead 5 attached to the positive electrode of the electrode group, is welded to a sealing plate 2 provided with a safety valve which operates when internal pressure of the battery rises. A negative electrode lead 6a attached to the negative electrode of the electrode group, is welded to the inner bottom face of the battery case 1. Thereafter, a non-aqueous electrolyte is injected into the battery case 1. The opening of the battery case 1 is sealed by crimping the opened end thereof onto the sealing plate 2, with a gasket 3 interposed therebetween.

A metal or alloy having electronic conductivity as well as resistance to electrolyte is used for the battery case 1, the positive electrode lead 5a, and the negative electrode lead 6a. For example, metals such as iron, nickel, titanium, chromium, molybdenum, copper, and aluminum, or alloys thereof are used. Stainless steel or an Al—Mn alloy is preferably used for the battery case. Aluminum is preferably used for the positive electrode lead. Nickel or aluminum is preferably used for the negative electrode lead. For the battery case, various engineering plastics may be used alone or in combination with a metal, in order to make it lightweight.

In addition, as a safety device, a protective function such as a fuse, a bimetal, and a PTC device may also be added to the battery. Further, as a countermeasure against rise of internal pressure of the battery other than placing a safety valve, a means by which a notch is created in the battery case, by which a crack is created in the gasket, by which a crack is created in the sealing plate, or by which the positive or negative electrode is cut, may be used. Furthermore, as a countermeasure against overcharge and overdischarge, a protective circuit may be incorporated in a charger, or may be separately and independently connected to the battery. For the method to weld the cap, the battery case, the sheet, or the lead, a known method (e.g., AC or DC electric welding, laser welding, or ultrasonic welding) may be used. Also, a conventionally-known material such as asphalt may be used for the sealing agent to seal the battery.

The shape of the battery is not particularly limited, and may be in the shape of any one of the following: coin, button, sheet, cylinder, flat, and prism. When the battery shape is of a coin or a button, the positive and negative electrode material mixtures are compressed into pellets for use. The thickness and diameter of the pellet may be determined in accordance with battery size. Note that the shape of the electrode group is not limited to a perfect cylinder, and may be an elliptic cylinder, or a rectangular prism.

### (5) Capacity Designs of First Cell and Second Cell

The second cell has a larger cell capacity than the first cell. The first cell preferably has a positive electrode capacity that is smaller than the negative electrode capacity. In the first cell, the overcharge region is larger for the positive electrode, and therefore, as with a typical lithium ion secondary battery, it is preferable to designate the first cell as a positive electrode-limited cell in which the cell capacity is determined by the positive electrode capacity.

The second cell preferably has a negative electrode capacity that is smaller than the positive electrode capacity. That is, it is preferable to designate the second cell as a negative electrode-limited cell in which the cell capacity is determined by the negative electrode capacity.

The reason for the above is as follows. The second cell becomes overcharged at the end of charge, when there is capacity loss therein due to some reason and its cell capacity becomes smaller than that of the first cell. In the case where the unit cell is in an overcharged state, damage to the unit cell is smaller when the negative electrode potential becomes lower, than when the positive electrode potential becomes higher.

Specifically, damage to the unit cell referred to herein is equivalent to the dissolving of metal in the positive electrode active material, the oxidative decomposition of the electrolyte, or the oxidative decomposition of the separator, which tends to easily occur when the positive electrode potential becomes high above the normal potential range. In contrast, when the negative electrode potential becomes low below the normal potential range, the effect on the unit cell is to the extent that reductive decomposition of the electrolyte occurs only slightly. Therefore, the second cell is preferably designated as the negative electrode-limited cell.

Also, in the case of a negative electrode-limited cell, aluminum foil or aluminum-alloy foil is preferably used for the negative electrode current collector. When a negative electrode-limited cell is discharged to 0 V, the negative electrode potential relative to a lithium metal may increase to around 4 V.

If the typically-used copper foil is used for the negative electrode current collector, the copper thereof would tend to be easily dissolved, thereby possibly causing an internal short circuit as a result. In contrast, if aluminum foil or aluminum-alloy foil is used for the negative electrode current collector, melting of the current collector as above would be suppressed.

Herein, the positive electrode capacity being larger than the negative electrode capacity means that a positive electrode capacity Q(p) and a negative electrode capacity Q(n) satisfy a relational expression: Q(p)/Q(n)>1, and the negative electrode capacity being larger than the positive electrode capacity means that the positive electrode capacity Q(p) and the negative electrode capacity Q(n) satisfy a relational expression: Q(p)/Q(n)<1. Such combination of the positive electrode and the negative electrode can be easily adjusted by appropriately determining the amounts of active materials to be filled as well as appropriately selecting the materials to be used as the active materials.

Also, “capacity” referred to herein is about “theoretical capacity”. “Positive electrode capacity” means the reversible capacity during charge and discharge carried out within the potential range of 2 to 4.5 V versus a lithium metal, although this varies to a certain extent depending on the combination of the materials. “Negative electrode capacity” means the reversible capacity during charge and discharge carried out within the potential range of 0.0 to 2.0 V versus a lithium metal.

### (6) Assembled Battery

The following is an example configuration of the assembled battery of the present invention.

(First Cell)

Positive electrode: LiNi_{1/3}Mn_{1/3}Co_{1/3}O₂

Negative electrode: Li₄Ti₅O₁₂

Capacity-limiting electrode: Positive electrode

(Second Cell)

Positive electrode: Li[Li_{0.1}Al_{0.1}Mn_{1.8}]O₄

Negative electrode: Li₄Ti₅O₁₂

Capacity-limiting electrode: Negative electrode

(Capacity Designs of First Cell and Second Cell)

The second cell has a larger cell capacity than the first cell (e.g., larger by 5%). That is, the negative electrode of the second cell has a larger capacity than the positive electrode of the first cell.

(Assembled Battery)

Four of the first cell and one of the second cell are connected in series.

The assembled battery of the above configuration is charged at a constant current until a voltage of 15 V is reached. At this time, the voltage of each unit cell is approximately 3 V. Even when variation in capacity, such being inevitable in manufacturing, occurs among the five unit cells connected in series, variation in voltage does not increase since change in charge voltage at near 15 V is moderate. At near 15 V, the second cell is not yet charged to the end of charge (not in a fully-charged state) and change in charge voltage is thus small. Even when the assembled battery is overcharged due to control error, the second cell quickly reaches the end of charge, the voltage rapidly increases, and the current flowing in the assembled battery becomes small.

Thus, overcharge in the first cell can be suppressed, thereby ensuring safety during overcharge. With respect to the second cell, since the overcharge region is extremely small, the positive electrode active material used in the cell exhibits almost no change between when the cell is in a normally-charged state and when the cell is in an overcharged state.

In the case of the assembled battery made solely of five of the first cell connected in series, there is not much change in charge voltage near 15 V. Thus, variation in capacity which is inevitable in manufacturing, becomes reduced. However, when the assembled battery becomes overcharged due to control error, the first cells become overcharged and thermal stability cannot be ensured.

Also, in the case of the assembled battery made solely of five of the second cell connected in series, there is significant change in charge voltage near 15 V. Thus, when there is variation in capacity among the unit cells, the variation in voltage thereamong becomes extremely large, and the cell with smaller capacity is thus overcharged during normal charging. The overcharged unit cell is greatly damaged, with degradation in cycle life and reduction in long-term reliability. Thus, in this case, charge control would be necessary for each unit cell, and this would result in a cost increase.

From the above, the assembled battery of the present invention is capable of remarkably curbing costs required for wiring and charge control, and of sufficiently ensuring safety even when there are occurrences of control errors. Also, there is improvement in long-term reliability since variation in capacity can be reduced.

It is preferable that the first cell and the second cell are easily identifiable, so as to improve work efficiency during production of the assembled battery. For example, changing cell sizes, changing cell colors, or attaching identification marks is preferable.

### EXAMPLES

The present invention is described in the following, specifically by way of Examples. However, the present invention is not to be construed as being limited to the following examples.

### Example 1

A first unit cell (cell P1) and a second unit cell

(cell Q1) were respectively produced in the following manner.

### (A) Production of Cell P1

### (1) Production of Positive Electrode

[Ni_{1/3}Mn_{1/3}Co_{1/3}](OH)₂ obtained by coprecipitation was sufficiently mixed with LiOH.H₂O, and the resultant mixture was then formed into a pellet. This pellet was baked at 1000° C. in air for 6 hours to obtain LiNi_{1/3}Co_{1/3}Mn_{1/3}O₂ as a positive electrode active material.

N-methyl-2-pyrrolydone (NMP) was added to a mixture containing 88 parts by weight of the positive electrode active material, 6 parts by weight of acetylene black as a conductive material, and 6 parts by weight of polyvinylidene fluoride (PVdF), to obtain a positive electrode slurry. This positive electrode slurry was applied to a positive electrode current collector made of aluminum foil. After the application, drying was conducted at 100° C. for 30 minutes, followed by further drying at 85° C. for 14 hours under vacuum, to obtain a positive electrode constituted of the positive electrode current collector with a positive electrode active material layer formed thereon.

### (2) Production of Negative Electrode

Lithium carbonate (Li₂CO₃) and titanium oxide (TiO₂) were mixed in such a manner that a desired composition was attained, and the resultant mixture was then baked at 900° C. in air for 12 hours, to obtain Li₄Ti₅O₁₂ as a negative electrode active material.

NMP was added to a mixture containing 88 parts by weight of the negative electrode active material, 6 parts by weight of acetylene black as a conductive material, and 6 parts by weight of PVdF as a binder, to obtain a negative electrode slurry. This negative electrode slurry was applied to a negative electrode current collector made of aluminum foil. After the application, drying was conducted at 100° C. for 30 minutes, followed by further drying at 85° C. under vacuum for 14 hours, to obtain a negative electrode constituted of the negative electrode current collector with a negative electrode active material layer formed thereon.

### (3) Assembling of Battery

With use of the positive electrode and the negative electrode obtained as above, a 18650-type cylindrical lithium ion secondary battery as in FIG. 1 was produced as follows.

The positive electrode and the negative electrode produced as above were each cut to have a width capable of being inserted in a battery case 1, to obtain a positive electrode 5 and a negative electrode 6 each shaped as a strip. A positive electrode lead 5a and a negative electrode lead 6a were respectively welded by ultrasonic welding, to the positive electrode 5 and the negative electrode 6 at predetermined positions. The positive electrode 5 and the negative electrode 6 were wound with a separator 7 (Celgard #2500 available from Celgard, LLC.) interposed therebetween to constitute an electrode group. The electrode group was housed in the battery case 1, followed by injecting 5 g of a non-aqueous electrolyte therein. For the non-aqueous electrolyte, a mixed solvent containing EC and MEC (volume ratio of 1:3) with 1.5 M LiPF₆ dissolved therein was used. At this time, insulating rings 8a and 8b were disposed on the top and bottom of the electrode group, respectively. The negative electrode lead 6a attached to the negative electrode 6 of the electrode group was connected to an inner bottom face of the battery case 1, the battery case 1 serving as a negative electrode terminal. The positive electrode lead 5a attached to the positive electrode 5 of the electrode group was connected to a sealing plate 2, the sealing plate 2 serving as a positive electrode terminal. The battery case 1 was sealed by crimping the opened end thereof onto the peripheral edge of the sealing plate 2, with a gasket 3 interposed therebetween. In this manner, the 18650-type cylindrical lithium ion secondary battery was obtained. This was designated as a cell P1.

Note that at the time of producing the above cell P1, the positive electrode thickness and the negative electrode thickness were set to 0.250 mm and 0.230 mm, respectively, and the positive electrode density and the negative electrode density were set to 2.88 g/cm³ and 2.1 g/cm³, respectively, for the battery capacity to be limited by the positive electrode capacity. The ratio (Q(p)/Q(n)) of the positive electrode capacity to the negative electrode capacity was set to 0.94.

### (B) Production of Cell Q1

### (1) Production of Positive Electrode

Manganite (MnOOH), aluminum hydroxide (Al(OH)₃), and lithium hydroxide (LiOH) were sufficiently mixed in such a manner that a desired composition is attained, and the resultant mixture was press formed to obtain a pellet. This pellet was subjected to baking (first baking) at 550° C. in air for 10 to 12 hours. The pellet after the first baking was pulverized, and the resultant pulverized material was subjected to baking (second baking) at 750° C. in air for 10 to 12 hours. In this manner, Li[Li_{0.1}Al_{0.1}Mn_{1.8}]O₄ was obtained as a positive electrode active material.

NMP was added to a mixture containing 88 parts by weight of the positive electrode active material, 6 parts by weight of acetylene black as a conductive material, and 6 parts by weight of PVdF as a binder, to obtain a positive electrode slurry. This positive electrode slurry was applied to a positive electrode current collector made of aluminum foil. After the application, drying was conducted at 150° C. for 30 minutes, followed by further drying at 85° C. under vacuum for 14 hours, to obtain a positive electrode constituted of the positive electrode current collector with a positive electrode material mixture layer formed thereon.

### (2) Production of Negative Electrode

Lithium carbonate (Li₂CO₃) and titanium oxide (TiO₂) were mixed in such a manner that a desired composition is attained, and the resultant mixture was baked at 900° C. in air for 12 hours, to obtain Li₄Ti₅O₁₂ as a negative electrode active material.

NMP was added to a mixture containing 88 parts by weight of the negative electrode active material, 6 parts by weight of acetylene black as a conductive material, and 6 parts by weight of PVdF as a binder, to obtain a negative electrode slurry. This negative electrode slurry was applied to a negative electrode current collector made of aluminum foil. After the application, drying was conducted at 150° C. for 30 minutes, and further drying was conducted at 85° C. under vacuum for 14 hours, to obtain a negative electrode constituted of the negative electrode current collector with a negative electrode active material layer formed thereon.

### (3) Assembling of Battery

With use of the positive electrode and the negative electrode obtained as above, a 18650-type cylindrical lithium ion secondary battery as in FIG. 1 was produced as follows.

The positive electrode and the negative electrode produced as above were each cut to have a width capable of being inserted in a battery case 1, to obtain a positive electrode 5 and a negative electrode 6 each shaped as a strip. A positive electrode lead 5a and a negative electrode lead 6a were welded by ultrasonic welding, to the positive electrode 5 and the negative electrode 6 at predetermined positions, respectively. The positive electrode 5 and the negative electrode 6 were wound with a separator 7 (Celgard #2500 available from Celgard, LLC.) interposed therebetween, to constitute an electrode group. The electrode group was housed in the battery case 1, followed by injecting 5 g of a non-aqueous electrolyte therein. For the non-aqueous electrolyte, a mixed solvent containing EC and EMC (volume ratio of 1:3) with LiPF₆ dissolved therein at a concentration of 1.5 mol/L was used. At this time, insulating rings 8a and 8b were disposed on the top and bottom of the electrode group, respectively. The negative electrode lead 6a attached to the negative electrode 6 of the electrode group was connected to an inner bottom face of the battery case 1, the battery case 1 serving as a negative electrode terminal. The positive electrode lead 5a attached to the positive electrode 5 of the electrode group was connected to a sealing plate 2, the sealing plate 2 serving as a positive electrode terminal. The battery case 1 was sealed by crimping the opened end thereof onto the peripheral edge of the sealing plate 2, with a gasket 3 interposed therebetween. In this manner, the 18650-type cylindrical lithium ion secondary battery was obtained. This was designated as a cell Q1.

Note that at the time of producing the above cell Q1, the positive electrode thickness and the negative electrode thickness were set to 0.250 mm and 0.182 mm, respectively, and the positive electrode density and the negative electrode density were set to 2.6 g/cm³ and 2.1 g/cm³, respectively, for the battery capacity to be limited by the negative electrode capacity. The ratio (Q(p)/Q(n)) of the positive electrode capacity to the negative electrode capacity was set to 1.08. The cell Q1 (negative electrode capacity) was made 5% larger than the cell P1 (positive electrode capacity).

The above cells P1 and Q1 were each charged and discharged twice under the following conditions, and then stored under a 40° C. environment for two days (pretreatment).

Charge: Under a 25° C. environment, the cell was charged at a constant current of 400 mA until a cell voltage of 2.9 V was reached, and then charged at a constant voltage of 2.9 V until the charge current reduced to 50 mA.

Discharge: Under a 25° C. environment, the cell was discharged at a constant current of 400 mA until a cell voltage of 1.5 V was reached.

Subsequently, four of the P1 cell and one of the Q1 cell were prepared, and these five cells were connected in series to produce an assembled battery A1 of Example 1.

### Example 2

Artificial graphite was used as the negative electrode active material. The positive electrode thickness and the negative electrode thickness were set to 0.140 mm and 0.175 mm, respectively. The positive electrode density and the negative electrode density were set to 2.88 g/cm³ and 1.2 g/cm³, respectively. The ratio (Q(p)/Q(n)) of the positive electrode capacity to the negative electrode capacity was set to 0.94. Copper foil was used for the negative electrode current collector. Other than the above, a cell P2 (first cell) was produced in the same manner as for the cell P1 of Example 1.

Artificial graphite was used as the negative electrode active material. The positive electrode thickness and the negative electrode thickness were set to 0.150 mm and 0.109 mm, respectively. The positive electrode density and the negative electrode density were set to 2.60 g/cm³ and 1.2 g/cm³, respectively. The ratio (Q(p)/Q(n)) of the positive electrode capacity to the negative electrode capacity was set to 0.94. Copper foil was used for the negative electrode current collector. Other than the above, a cell Q2 (second cell) was produced in the same manner as for the cell Q1 of Example 1. The cell Q2 (positive electrode capacity) was made 10% larger than the cell P2 (positive electrode capacity).

The above cells P2 and Q2 were each charged and discharged twice under the following conditions, and then stored under a 40° C. environment for two days (pretreatment).

Charge: Under a 25° C. environment, the cell was charged at a constant current of 400 mA until a cell voltage of 4.2 V was reached, and then charged at a constant voltage of 4.2 V until the charge current reduced to 50 mA.

Discharge: Under a 25° C. environment, the cell was discharged at a constant current of 400 mA until a cell voltage of 2.5 V was reached.

Two of the P2 cell and one of the Q2 cell were prepared, and these three cells were connected in series to obtain an assembled battery A2 of Example 2.

### Comparative Example 1

Five of the above cell P1 were connected in series to obtain an assembled battery B1 of Comparative Example 1.

### Comparative Example 2

Five of the above cell Q1 were connected in series to obtain an assembled battery C1 of Comparative Example 2.

### Comparative Example 3

Three of the above cell P2 were connected in series to obtain an assembled battery B2 of Comparative Example 3.

### Comparative Example 4

Three of the above cell Q2 were connected in series to obtain an assembled battery C2 of Comparative Example 4.

### [Evaluation]

For the assembled batteries of Examples 1 and 2 and Comparative Examples 1 to 4 obtained above, their respective overcharge characteristics when undergoing a charge/discharge cycle were evaluated as follows.

Under a 25° C. environment, the assembled batteries A1, B1, and C1 were each charged at a constant current of 1400 mA until a battery voltage of 15.0 V was reached, and then charged at a constant voltage of 15.0 V until the charge current was reduced to 30 mA.

Under a 25° C. environment, the assembled batteries A2, B2, and C2 were each charged at a constant current of 1400 mA until a battery voltage of 13.4 V was reached, and then charged at a constant voltage of 13.4 V until the charge current was reduced to 30 mA.

Subsequently, the assembled batteries A1 to C1 and A2 to C2 were each discharged at a constant current of 2000 mA until a battery voltage of 11.5 V was reached.

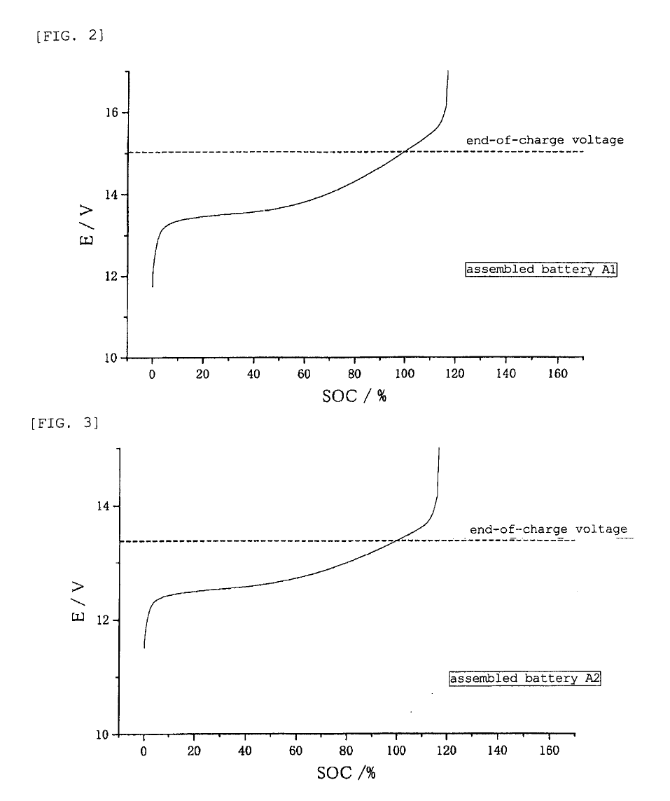

This charge/discharge was repeated for 10 cycles, and then, with the assumption that the assembled battery overcharges due to control error, each battery was overcharged at 1400 mA until a battery voltage of 15 to 17 V was reached. Specifically, the assembled batteries A1, B1, C1, and C2 were each overcharged until 17 V was reached. The assembled batteries A2 and B2 were each overcharged until 15 V was reached. The respective charge curves at that time are shown in FIGS. 2 to 7. Note that the horizontal axis in each figure represents SOC (%) which is a value indicating the percentage charged, the fully-charged state being 100%, and the vertical axis in each figure represents the voltage E (V) of the assembled battery.

As shown in FIGS. 2 and 3, it became evident that for each of the assembled battery A1 of Example 1 and the assembled battery A2 of Example 2, the slope of the charge curve at the end-of-charge voltage was small and the overcharge region (SOC) was small. That is, it became evident that the assembled batteries A1 and A2 each had excellent safety during overcharge and excellent long-term reliability.

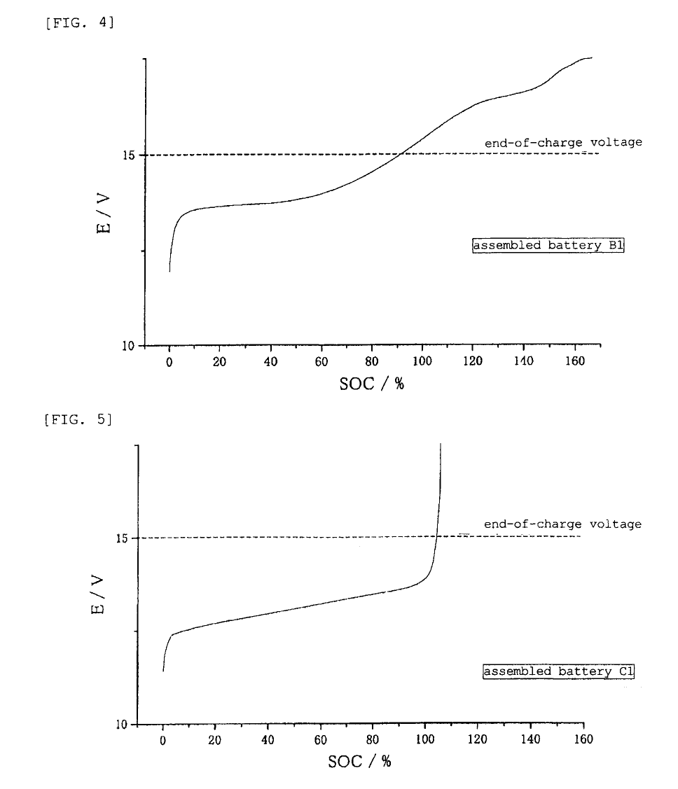

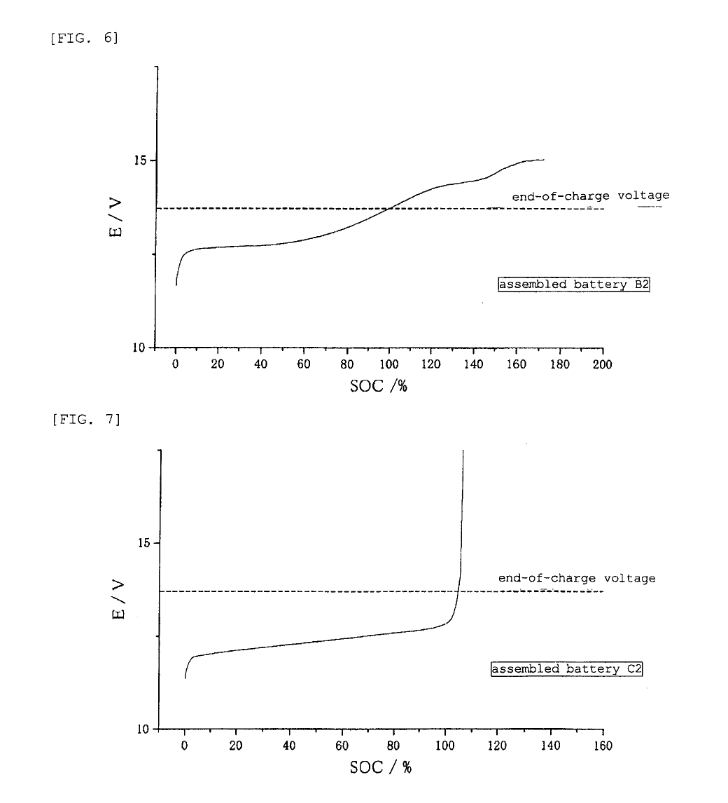

As shown in FIGS. 4 and 6, it became evident that for each of the assembled battery B1 of Comparative Example 1 and the assembled battery B2 of Comparative Example 3, the slope of the charge curve at the end-of-charge voltage was small but the overcharge region (SOC) was large, and that safety during overcharge was low. As shown in FIGS. 5 and 7, it became evident that for each of the assembled battery C1 of Comparative Example 2 and the assembled battery C2 of Comparative Example 4, the slope of the charge curve at the end-of-charge voltage was large, thus making the cells being easily affected by variation in capacity and being low in reliability.

### INDUSTRIAL APPLICABILITY

The assembled battery of the present invention is suitably used as a power source or a backup power source for electronic devices.

1. An assembled battery comprising at least one first cell and at least one second cell connected in series, wherein said second cell has a greater change in charge voltage at the end of charge and a larger cell capacity, compared to said first cell.

2. The assembled battery in accordance with claim 1, wherein a positive electrode active material of said first cell is a lithium-containing composite oxide having a layered structure.

3. The assembled battery in accordance with claim 2, wherein said lithium-containing composite oxide is represented by a general formula (1):
Li₁₊ₐ[Me]O₂
where Me is at least one selected from the group consisting of Ni, Mn, Fe, Co, Ti, and Cu; and 0≦a≦0.2.

4. The assembled battery in accordance with claim 2, wherein said lithium-containing composite oxide is represented by a general formula (2):
Li₁₊ₐ[Ni_{1/2-z}Mn_{1/2-z}Co_{2z}]O₂
where 0≦a≦0.2 and z≦1/6.

5. The assembled battery in accordance with claim 1, wherein a positive electrode active material of said second cell is a lithium-containing manganese composite oxide having a spinel structure.

6. The assembled battery in accordance with claim 5, wherein said lithium-containing manganese composite oxide is represented by a general formula (3):
Li₁₊ₓMn_{2-x-y}A_{y}O₄
where A is at least one selected from the group consisting of Al, Ni, Co, and Fe; 0≦x<1/3; and 0≦y≦0.6.

7. The assembled battery in accordance with claim 1, wherein a positive electrode active material of said second cell is a phosphate compound having an olivine structure.

8. The assembled battery in accordance with claim 7, wherein said phosphate compound is represented by a general formula (4):
Li₁₊ₐMPO₄
where M is at least one selected from the group consisting of Mn, Fe, Co, Ni, Ti, and Cu; and −0.5≦a≦0.5.

9. The assembled battery in accordance with claim 1, wherein a negative electrode active material of at least one of said first cell and said second cell is a lithium-containing titanium oxide.

10. The assembled battery in accordance with claim 9, wherein said lithium-containing titanium oxide is represented by a general formula (5):
Li₃₊₃ₓTi₆₋₃ₓO₁₂
where 0≦x≦1/3.

11. The assembled battery in accordance with claim 9, wherein said lithium-containing titanium oxide comprises a mixture of primary particles with a particle size of 0.1 to 8 μm and secondary particles with a particle size of 2 to 30 μm.

12. The assembled battery in accordance with claim 1, wherein a negative electrode current collector of at least one of said first cell and said second cell comprises aluminum or an aluminum alloy.

13. The assembled battery in accordance with claim 1, wherein said first cell differs from said second cell in size.

14. The assembled battery in accordance with claim 1, wherein said first cell differs from said second cell in color.

15. The assembled battery in accordance with claim 1, wherein a first identification marking is attached on a surface of said first cell, a second identification marking is attached on a surface of said second cell, and said first cell can be identified from said second cell due to said first identification marking and said second identification marking.
